(19) United States
(12) Patent Application Publication
(10) Pub. No.: US 2006/0218013 A1
(43) Pub. Date: Sep. 28, 2006

(54) Electronic directory of health care information

(76) Inventors: John Si Nahra, Plymouth, MI (US); Kevin Michael Juszczyk, Northville, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/384,873

(22) Filed: Mar. 20, 2006

Related U.S. Application Data
(60) Provisional application No. 60/664,650, filed on Mar. 24, 2005.

(51) Int. Cl. G06F 19/00; G06F 7/00

(52) U.S. Cl. 705/3; 707/102

(57) ABSTRACT

A system for assisting the exchange of information between healthcare providers, third party payors and persons receiving healthcare, employs an electronic data index with a record for each person identified listing the payors and/or providers with data regarding that person and instructions for accessing these data. The index records are established and may be accessed through a hash function based on covered persons' names and further identification such as birthdates. Authorized Requestors seeking information with regard to a covered person enter the person's name and further identifying information into a hash value generator in order to create the identifying hash function. A hash table identifies the location of the index record related to that individual in the data index. The index record identifies payors and providers with data on the person associated with the index record. The index record also contains instructions for accessing these files from the payors and providers. This process enables the retrieval of all data on the person in a convenient, anonymous and error-free manner.

### RELATED APPLICATION

This application claims priority of U.S. Provisional Patent Application Ser. No. 60/664,650 filed Mar. 24, 2005, which is incorporated herein by reference.

### FIELD OF THE INVENTION

This invention relates to an electronic database reference system for facilitating communication between and among third party payors and healthcare providers regarding individuals for whom healthcare services are performed and more particularly to such a system which uses the individual's name and further identifying information to create a hash value to determine the location of remote databases associated with that individual and protocols for gaining access to the databases in a manner that protects individual identity, data confidentiality, and the integrity of the databases being accessed.

### BACKGROUND OF THE INVENTION

The large number of independent providers of healthcare services in the United States and the large number of healthcare payors, many of whom may provide overlapping coverage for numerous individuals, complicates the problem of achieving the many necessary communications between payors, providers, and each other to minimize numerous problems, such as duplicate payments, forfeiture of the value of benefits by covered persons, accurate determination of which persons are uninsured, and abuses such as payors attempting to avoid their legal liability or providers seeking duplicate payment. The lack of an efficient system for determining the payors having coverage for a person, the providers to a person and the like, has created a very inefficient system with excessive costs. Informal studies have observed that between 5 and 15% of persons classified as uninsured by providers are actually enrolled in at least one payor program. Also 10-20% of persons with health coverage have multiple payor relations that have gone unreported to the providers.

Previous efforts to solve this problem and provide effective communications between interested providers and payors include the following:

1. Self-reporting by individuals: This requires individuals to have complete, current and accurate information about coverage including their enrollment in group health arrangements and a variety of available personal accounts (HSA, MSA, HRA, etc.). Individuals often do not have this information or are unwilling to share it, especially in situations at the coverage extremes where the person is either uninsured or has multiple payor relationships. Further, the individuals must be able to communicate this information so persons too ill to communicate or those that have not been asked the right questions will remain unidentified. Finally, they must be willing to share the information. Growing concerns over identity theft and the privacy of personal communications are increasing the frequency with which individuals do not fully report coverage information.

2. Central repository of payors' data: Numerous attempts have been made by payors to create and maintain a shared repository of enrollment information. All have failed because of privacy issues, liability exposures and competitive concerns. Furthermore, standardized maintenance processes and synchronization of changes across multiple data sources have proven to be insurmountable technical impediments to these solutions.

3. EDI broadcast: The advent of electronic data interchange (EDI) speeds up the exchange of information. It has been suggested that the increased speed might make it possible to canvass all payors to identify those with information on an individual without requiring the individual to self-report and without using a central repository. While theoretically appealing, this approach is impractical since many payors do not support electronic data interchange and, even among those that do, idiosyncrasies in payor requirements generally complicate the execution of any canvass. Secondly, as the number of patients and payors increases, the bandwidth required for the EDI links grows at an exponential rate. At some point, the bandwidth costs outweigh any benefit attained from the exchange.

### SUMMARY OF THE INVENTION

The present invention accordingly provides a system for the exchange of healthcare information about individuals between and among providers and payors which is quick, highly reliable, and simple in operation. Broadly, the present invention creates an index file (the Lockbox Index) containing a record (the Lockbox Index Record) for each person, i.e. patient or enrollee, identified by a payor or provider (referred to collectively as “Contributors”) as included in one or more of the Contributor's databases. Each person's Lockbox Index Record identifies the Contributors with data on that person and instructions on how to access the Contributors' databases. Persons in multiple databases will have multiple Contributors listed in their Lockbox Index Record. Persons not in any Contributors' databases will have a blank Lockbox Index Record. Data held by Contributor(s) relative to a person may include enrollment and entitlement information from all known payors for that individual; service billing records to primary and secondary payors; coordination-of-benefits (COB) records; service remittance records; medical records; providers' notices and the like.

The term “Lockboxes” is used to emphasize the secure aspect of the system. In order to make a contribution or access information previously stored in the Lockbox, the name of a person and additional identifying information, preferably the person's birth date, are processed by a mathematical algorithm (referred to as the Lockbox Locator) to derive a hash value. This hash value is arrayed with all other hash values as an index or locator address to the Lockboxes in a hash table. In order to obtain access to a particular Lockbox, the identifying information of the person is processed through the Lockbox Locator to derive the hash value and pinpoints the exact spot in the Lockbox Index where the person's Lockbox Index Record can be found. This obviates the need to laboriously compare a search request based on the user's name with each file in the database to locate pertinent records.

Additionally, use of the hash functions to assign and locate a person's Lockbox Index Record introduces a level of security since the hash function is not reversible and it is not possible to derive a person's name knowing only the hash function. By combining the Lockbox Locator hash function with the Lockbox Index, multiple parties can employ the identifying information to quickly access information stored in the pertinent Lockbox in a secure manner. Data in the Lockbox Index, may be stored and accessed in a manner which does not reveal the individual's identity to unauthorized parties.

In order to create the hash Lockbox Index, payors and/or providers (Contributors), on some scheduled regular basis, create a file containing the identifying information for all persons in their databases alone with instructions on how to access these remote databases maintained by the Contributor. This identifying information is processed by the Lockbox Locator hash function algorithm to produce a unique hash value for each person. The proprietor then creates a hash table establishing correspondence between the hash values in the hash table and the particular Lockboxes of the Lockbox Index and the content of the Lockbox Index Record on Contributors and their source files.

Individuals may also provide information to be stored in the hash Lockbox Index by reporting to the Index proprietor their identifying information along with the name or names of payor coverage programs in which they are enrolled or providers they use.

The proprietor stores in each hash Lockbox associated with a hash value the name of each payor or provider for the individual. Along with the payor/provider name would be an electronic link to instructions on how to access these remote databases maintained by the Contributor. A party requesting access to the Lockbox information for a particular person, typically a provider seeking coverage verification or coordinating care or a payor coordinating coverage (referred to collectively as Requestors), would submit the identifying information for that person to the proprietor. The Requestor may use the proprietary hash function to derive the hash values for submission to the proprietor or may provide the basic identifying information for conversion to hash values by the proprietor. Using the hash value to identify a particular Lockbox, the contents of that Lockbox would then be communicated to the Requestor electronically in the form of the Lockbox Index Report.

### BRIEF DESCRIPTION OF THE DRAWINGS

Other objects, advantages and applications of the present invention will be made apparent by the following detailed description of a preferred embodiment of the invention. The description makes reference to the accompanying drawings in which:

FIG. 1 is a flow chart illustrating the method and apparatus for providing information relating to a particular individual for storage in the Lockbox Index;

FIG. 2 is a flow chart illustrating the broad operation of the system and method of the present invention; and the relationship of the parties who utilize the Lockbox system of the present invention and that system;

FIG. 3 is a flow chart illustrating the operation of the system in providing Lockbox information to a provider or payor to enable enrollment verification of an individual from payors having contracts with the individual or to determine the identity of other service providers to that individual in order to coordinate care to the individual or to coordinate benefits and prevent fraud as well as to determine the identity of providers to that individual for payment purposes, care management and fraud prevention; and

FIG. 4 is a block diagram illustrating use of the system by a provider or payor to confirm that no other payor or provider has information about the individual in order to confirm lack of insurance coverage or that no prior health service history is available for review.

### DETAILED DESCRIPTION OF THE INVENTION

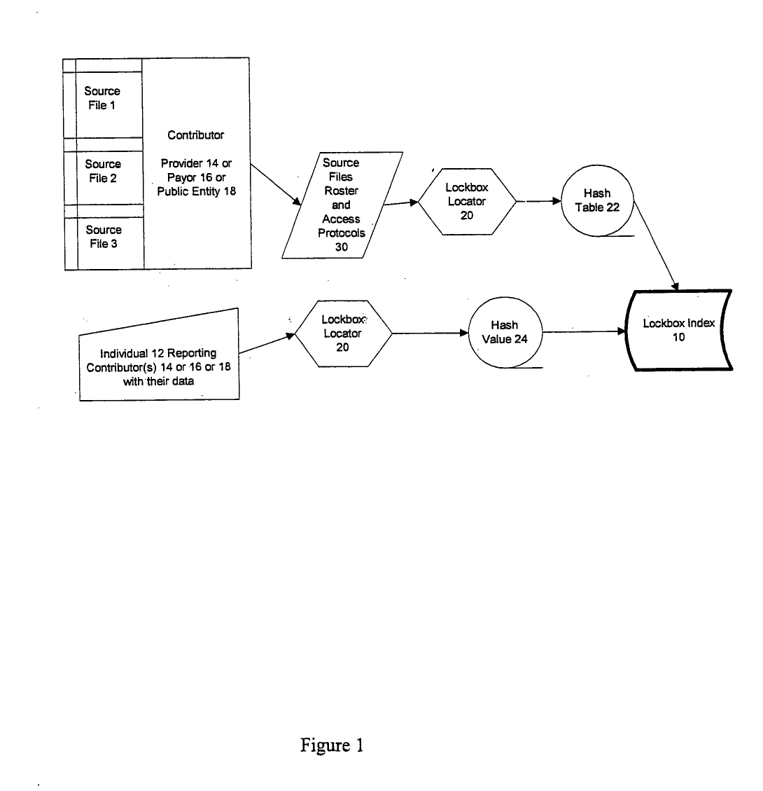

Referring to FIG. 1, the Lockbox Index 10 of the present invention constitutes a database index, typically stored in a large memory such as a hard drive or the like that is associated with a data processing system. The Lockbox Index stores a number of records or Lockboxes, one for each individual person associated with the system. The information stored in each individual's record identifies sources (Contributors) with data on that person. Contributors include healthcare providers 14 (including individual physicians, nutritionists, dentists, medical equipment suppliers, and others who provide goods or services to individual patients and depend upon third party payors for some or all of their reimbursement); the payors 16 (which may include government organizations such as Medicare and Medicaid, private insurers, self-insuring employers and the like); and public institutions 18 (including local, state and federal governments along with their associated agencies and programs).

Referring to FIG. 1, Contributors (14 or 16 or 18) possess various Source Files. For providers 14 these may be patient records or service billing files; for payors 16 these may be enrollment records or paid claim files; for public entities 18 these may be registration records or service history files. Each of these Contributors (14 or 16 or 18) retains control over their Source Files. Rather than reporting the content of the Source Files, which is the approach used by central data repositories, or permitting open access to the content of the Source Files, which is the approach used by data sharing exchanges, the present invention entails the Contributor 14/16/18 simply providing a Roster of persons 30 who are included in the Source Files. Particular individual information chosen for use by the Roster 30 may vary, but preferably constitutes the name and birth date of the individual. In other systems Social Security numbers or identifiers developed by payors may be used as identifying information for the individuals. Use of the name and birth date creates ease of reporting, facilitates verification and avoids concerns over identity theft associated with the Social Security number. With universal adoption, the Lockbox Identifier provides a national personal health identifier that is anonymous, secure, reliable, valid, and fully compliant with all federal and state privacy requirements.

Accompanying each Roster 30 are instructions from the Contributor 14/16/18 as to protocols to be followed by outside parties to gain access to the Contributors' Source Files.

The Roster 30 information associated with an individual person is then passed through a hash function generator referred to as the Lockbox Locator 20. Some of the Contributors 14/16/18 may themselves perform the hash function generation, which is not complicated, or alternatively the hash function generator may be provided as a part of the Lockbox array central system.

The hash function generator essentially takes the identifying information and operates upon it by a mathematical algorithm by essentially chopping and mixing the identifying information. The selection of hash functions is well known to computer science professionals. For example, see Database Management Systems, Third Edition, Ramakrishna and Gehrke, McGraw-Hill Higher Education, pp. 279, 372, 379 and 735. The hash function provides exactly the same hash value for that identifying information each time it is given the identifying information. The process is not reversible so that the hash value does not reveal the original identifying information used to produce it. In mathematical terms, the hash value is a one-way conversion. This provides a high level of security to the Lockbox array. Were the information in the Lockbox Index to fall into the wrong hands, it would be impossible to use that information to derive the identity of the individuals contained in the Contributor's Roster 30. The same security applies to the transmission of information between the contributors to the Lockbox Index and the Lockbox Index system. If the hash function is performed by the Contributors themselves, which is a simple process, the results sent to the Lockbox array system do not contain any information identifying the individuals.

The hash function generator 20 feeds a hash table 22 that is incorporated into the Lockbox Index 10. This hash table is a listing of all the hash values derived from Roster 30 of individual identifying information provided to the system by Contributors 14/16/18, and is arranged in numerical form. Use of the hash table greatly simplifies and minimizes the computation required to locate a particular Lockbox record associated with an individual based on the identifying information for an individual. Rather than comparing the identifying information with the addresses of each of the files contained in the Lockbox array, the hash table pinpoints the exact location in the Index of a record related to the individual given the unique hash value.

The Lockbox Index 10 can hold billions of records and permit consistent assignment of a person to the same location in the Lockbox Index 10. So a person with information stored in multiple Contributors 14/16/18 Source Files will be assigned to a single Lockbox Index 10 record and that record will list multiple Contributors 14/16/18. The identities of the Contributors 14/16/18 are accompanied by information as to how to access and communicate with the various Contributors' 14/16/18 Source Files.

Contributors 14/16/18 Rosters 30 of individuals for whom they have data is updated on a regular (daily, weekly or monthly) basis.

Individuals 12 may also contribute directly to the Lockbox Index 10. In this situation the Individual 12 would submit identifying information to the Lockbox Locator 20 along with a listing of Contributors 14/16/18 that have information on them. Rather than a Hash Table, the Lockbox Locator would produce an Individual's Hash Value 24 that would locate the Lockbox Index 10 record for that Individual and include as part of that record the Contributor(s) 14/16/18 listed by the Individual 12.

Various methods may be used to encourage the provision of information to the Lockbox Index 10. Individuals may make contributions electronically, telephonically, or via paper forms. The advantages they gain are privacy protection, assurance that full coverage value from all plans is provided, and the prevention of identity theft as a result of the secure features of the present invention. Providers 14 have incentive to make contributions to the Lockbox Index 10 to achieve income for their services and goods provided to insured, to confirm uninsured, and detect patient abuse. Payors 16 have incentive to make contributions to the Lockbox Index 10 to assure complete coordination of benefits with other Payors, prevent duplicate payment of benefits, achieve administrative savings and detect fraud. Public entities 18 have incentive to make contributions to achieve administrative savings, support their authorized functions, and provide public protection of information.

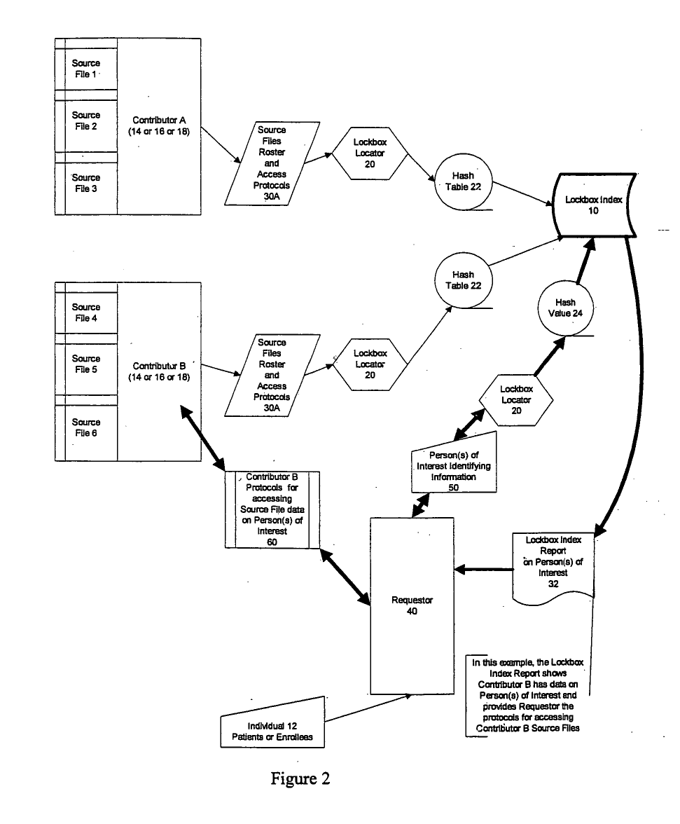

FIG. 2 illustrates in flow chart form the broad operation of the system for two Contributors. The number of participating Contributors is not limited so these two Contributors represent hundreds or thousands of possible Contributors. The sequence of events shown in FIG. 1 for Contributor 14/16/18 submittals to the Lockbox Index 10 are repeated here by all Contributors and form the top part of the Figure. Individual identifying Rosters 30 (preferably name and birth date) are derived from Source Files and provided to the hash function generator (Lockbox Locator 20). The hash function produces a hash table 22 that locates and assigns an individual hash value to a particular Lockbox Index 10 location along with the name of the Contributor submitting the hash value and instructions on accessing the Source File maintained by the Contributor that contains information on the individual associated with the hash value. The information in that Lockbox Index r(cord is then available for output as a Lockbox Index Report 32 that can be provided to a Requestor 40.

Any Contributor 12/14/16/18 can also be a Requestor 40. The Lockbox Index 10 can accommodate multiple Requestors simultaneously. The Requestor 40 in FIG. 2 represents hundreds or thousands of potential Requestors.

The Requestor process begins with Individual patients or enrollees of interest to the Requestor. The Requestor interest is in verifying which Contributors have available information about the Person and how to access that information. The heavier lines in the FIG. 2 flow chart denote Requestor 40 activities to accomplish this end.

A Requestor 40 obtains identifying information (name and birth date) on Persons of Interest 50. Persons of Interest 50 may be patients being seen by a provider 14, or enrollees in a payor 16 health plan, or participants in public entity 18 programs, or an individual 12 reviewing personal information.

The identifying information on Persons of Interest 5C may be for a single person or lists of people. This identifying information is passed through the same Lockbox Locator 20 program used by Contributors to assign hash values for placement of individuals in the Lockbox Index. When used by a Requestor 40 the Lockbox Locator 20 produces a Hash Value 24 for each instance of individual identifying information. This Hash Value 24 corresponds to that individual's record location in the Lockbox Index 10.

The Lockbox Index Report 32 produced from the match between the Hash Value 24 and the Lockbox Index 10 record tells the Requestor 40 which, if any, Contributors have information on the individual and how to access the Contributor Source Files containing this information. In the example from FIG. 2, Requestor 40 receives a Lockbox Index Report 32 telling them that Contributor B has information on the Person of Interest associated with that hash value and Lockbox Index Report. With a single request, a 100% canvass is performed of all available data sources for a person.

Since they made the request, the Requestor already knows who the Person of Interest associated with the Hash Value is. With the Information from the Lockbox Index Report 32, the Requestor 40 can take the information they have on individuals of interest and follow the Protocols for Accessing Source Files 60 defined by the Contributor. This makes possible an exchange of data on the Individual of Interest between the Contributor Source Files and the Requestor.

Use of the Lockbox Index Report 32 allows the Requestor to only access specific information approved by the Contributor B. No other information from Contributor B is accessed or available to the Requestor. Other Contributors not included in the Lockbox Index Report 32 (represented as Contributor A) have none of their data accessed by the Requestor. This feature of limited access to defined data following prescribed procedures assures the highest level of data protection for all Source Files. Source Files maintained remotely are only accessed as needed and required and approved.

As illustrated in FIG. 2, individuals 12, providers 14, payors 16, and public entities 18 all have communication with the Lockbox system which incorporates the Lockbox Index 10, and a hash function generator (Lockbox Locator) 20. Communication between various parties using the Lockbox Index system is preferably electronic using public networks such as the Internet. This allows communications to be initiated from any location having access to the Internet and greatly adds to the convenience and lowers the cost of the system.

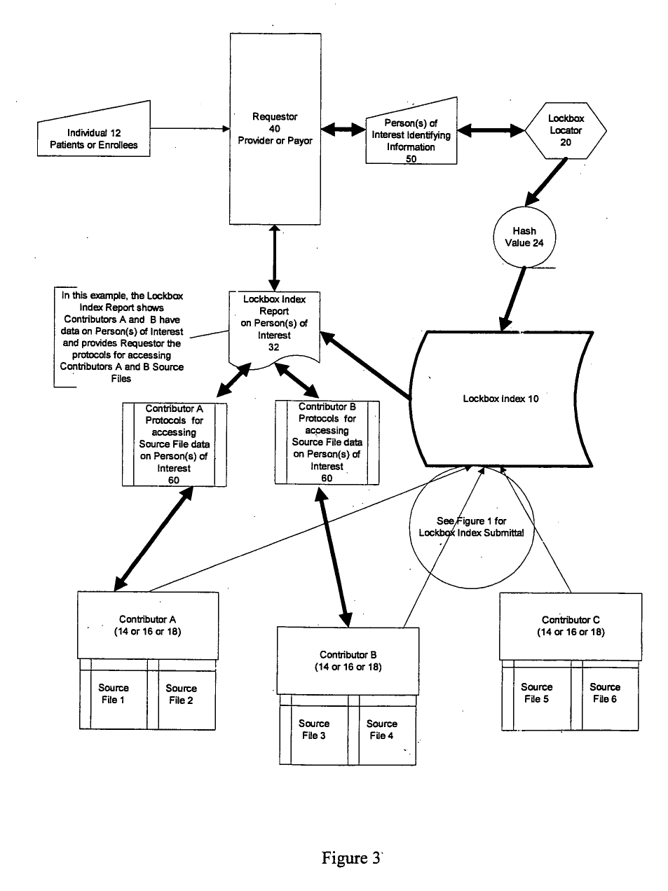

FIG. 3 is a flow chart illustrating the use of the Lockbox Index system by a provider or payor to derive information stored in the Lockbox Index in order to initiate a data exchange with other providers or payors that have data on persons of interest. The Contributor process from FIG. 1 is incorporated by reference at the bottom of FIG. 3. The three Contributors represent multiple Contributors as in FIG. 2. The Requestor process from FIG. 2 is reflected at the top of FIG. 3. The resulting Lockbox Index Report 32 in FIG. 3 shows the Requestor 40 that both Contributor A and Contributor B have information on the individual of interest in their Source Files and provides the Requestor with the protocols for initiating the data exchange.

In FIG. 3 the Requestor 40 might be a provider 14 seeking to confirm payors that have the individual of interest enrolled. In the Figure's example, the provider would know to contact Payor A and Payor B as payment sources but not Payor C (or the multiple other Payors represented by this Contributor C). Many (5% or more) patients classified as uninsured by providers have been found to be covered by a payor. This single request to the Lockbox Index would assure the provider that all appropriate payors have been identified and eliminate the possibility of missing a payment source or the requirement for further follow-up. Alternatively, a provider 14 may be seeking to identify other providers with information on the individual of interest so as to have a complete patient history and avoid unnecessary or perhaps harmful treatment. In the Figure's example, the provider would know to contact Provider A and Provider B but not Provider C (or the multiple other Providers represented by this Contributor C). This single request to the Lockbox Index would allow complete care coordination across otherwise unaffiliated and independent provider sites. Such care coordination is currently impossible in the United States.

In FIG. 3 the Requestor 40 might also be a payor 16 seeking to confirm other payors with information on an individual of interest so that determinations of who is the primary payor under coordination-of-benefit (COB) rules could be made. In the Figure's example, the payor would know to contact Payor A and Payor B as payment sources but not Payor C (or the multiple other Payors represented by this Contributor C). This single request to the Lockbox Index would assure the payor that all appropriate payors have been identified and all COB rules have been applied without the need for costly confirmation mailings and verification calls. This process would also eliminate the need for maintaining separate COB files that is an expensive, time-consuming and intrusive process. Alternatively, the payor 16 in FIG. 3 may be seeking to identify all providers caring for the person so as to avoid duplicate payment or to support care management services offered by the payor. This single request to the Lockbox Index will give the payor a complete inventory of providers involved in the individual's care without the need to have providers reveal confidential patient-provider relations that do not involve the payor.

The Requestor 40 in FIG. 3 may also be a public entity 18 performing either provider or payor functions. In addition to these roles, the public entity may be seeking to confirm regulatory compliance or protect individual rights or perform authorized police functions. In all these capacities, a single request to-the Lockbox Index would allow the public entity 18 to limit their focus to other involved parties saving time and money for the public sector while assuring that public review is as non-intrusive as possible.

The Requestor in FIG. 3 may also be an individual 12 seeking to confirm the extent and accuracy of personal health information and other private data held by third parties. In this case, the individual could confirm that only parties they have authorized have their confidential data and contact them to confirm the accuracy of the information. Parties with their data that are unknown to them could be identified with a single request to the Lockbox Index. This level of individual privacy protection does not currently exist in the United States.

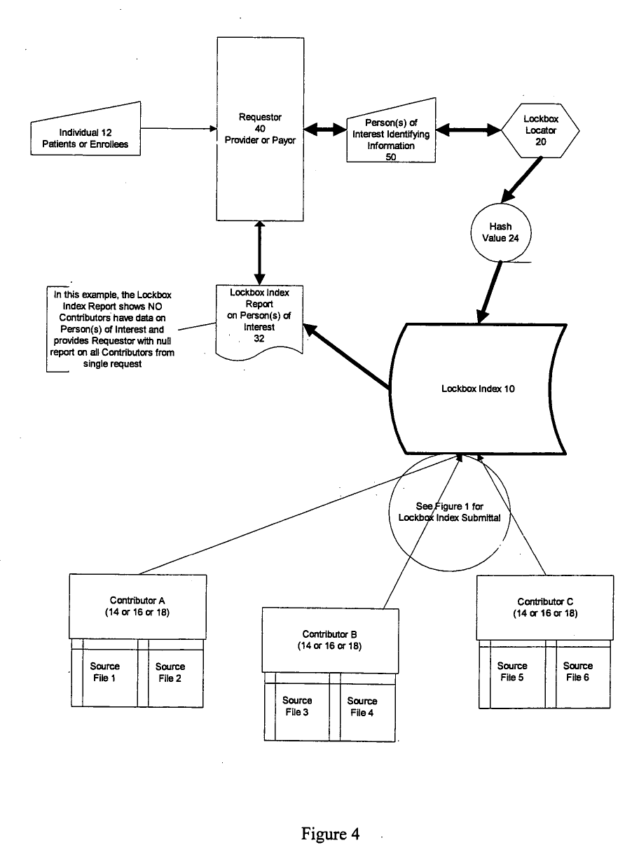

FIG. 4 mirrors FIG. 3 with one notable difference in FIG. 4 the Lockbox Index Report 32 informs the Requestor that no Contributor has indicated that the individual of interest is in any of their source files. This ability to produce “Null Findings” represents a significant advance in two-party communication in health care. Currently a payor or provider with no information on other sources of information on an individual has no way of knowing if this “Null Findings” is correct or a reflection of gaps in their identification or verification processes. Payors and providers each expend sizeable portions of their administrative expense seeking to assure the accuracy of “Null Findings” by confirming through individual surveys and follow-up the existence of other data sources of interest. FIG. 4 shows that with a single request to the Lockbox Index a provider would know they are that person's only care giver or that the person is truly uninsured. A payor would know that this individual has no other coverage for coordination and has not sought health care from a provider so claims received may be fraudulent. None of these tasks can be done with ease currently and when done, the accuracy of the results is always suspect and potentially out-of-date once reported. The Lockbox Index ability to produce “Null Findings” marks a major advance in health care processes and a source of substantial savings.

1. A system for anonymously storing information related to healthcare payors and providers for individual persons and/or related healthcare information, comprising:
a hash value generator (Lockbox Locator) adapted to receive identifying information related to an individual and to process such representative information to generate a hash value;
a data index (Lockbox Index) containing records related to individuals, stored on a hash value basis not otherwise identifying the individuals or their representative information; and
a hash table identifying the file locations in said database in terms of hash values;
whereby information relating to an individual may be contributed to and retrieved from said database in terms of hash values associated with the individual patients.

2. The system of claim 1 in which the individual identifying information includes the individual name.

3. The system of claim 2 in which the individual identifying information further includes the individual's birth date.

4. The system of claim 2 wherein the information further includes the patient's Social Security number.

5. The system of claim 1 in which the hash function generator, the hash table, and the data index are located at a central location and communication between contributors and recipients of information stored in the database and the database system are via public communication network.

6. The system of claim 1 in which the individual Contributors and Requestors of information from the database system maintain hash function generators so that the communication to and from the database array is via hash functions with no inclusion of personal identification information.

7. The system of claim 1 wherein the information relating to healthcare payors and healthcare providers stored in each file in the data index array includes information required to allow a receiving party to communicate with such payors and/or providers.

8. The system of claim 1 in which the database array is stored on hard disks.

9. The system of claim 1 in which the individuals comprise patients and/or enrollees.

10. The method of facilitating communications relative to individual patients and enrollees between healthcare providers and third party payors, comprising:
establishing a data index (Lockbox Index) containing records for each individual patient or enrollee identifying the associated providers and payors with healthcare information on that person (Contributors) and information necessary to communicate with such providers or payors, each record being identified by a hash value;
translating representative information relating to individuals into hash values by operating upon the digital value of such information with an algorithm to obtain a hash value; and
establishing a table of hash values and locations in the data index of records associated with those hash values;
whereby healthcare providers and third party payors may interrogate the database using hash values related to individual representative information and derive the stored information in an individual anonymous form (Lockbox Index Report).

11. The method of claim 10 in which the representative information includes the individual's name.

12. The method of claim 11 where the representative information further comprises the individual patient's birth date.

13. The method of claim 11 in which the individual information further comprises a Social Security-number.

14. The method of claim 10 wherein communication between the payors, providers and the database is performed using public networks.

15. The method of claim 14 wherein the public network comprises the Internet.

16. A system for anonymously storing and retrieving healthcare information related to an individual on an anonymous basis, comprising:
a data index system comprising:
a hash value generator (Lockbox Locator) for receiving individual identifying information relating to a patient, including the patient's name, and at least one additional item of individual identifying information;
a data index (Lockbox Index) containing a plurality of records each storing information relating to an individual, the files being identified on a hash value basis; and
a hash table relating hash values to locations in the data index; and
a public network for providing the information relating to the individual to the hash function generator to generate a hash value that may be used to interrogate the hash table to locate a record in the data index storing information relative to that patient and to provide such information to an interrogating party (Lockbox Index Report).
An electronic report (Lockbox Index Report) that provides the interrogating party (Requestors) with a listing of all the associated providers and payors with healthcare information on that person (Contributors) and information necessary to communicate with such providers or payors, each record being identified by a hash value.

17. The system of claim 16 wherein the individual information comprises the individual name and birth date.
